(19) United States
(12) Patent Application Publication
(10) Pub. No.: US 2006/0233693 A1
(43) Pub. Date: Oct. 19, 2006

(54) Process for preparing magnesium carbonate by supercritical reaction process of fluid

(76) Inventors: Jae Keun Lee, Seongnam-si (KR); Seung Soo Park, Daejeon (KR)

Correspondence Address: CANTOR COLBURN, LLP, 55 GRIFFIN ROAD SOUTH, BLOOMFIELD, CT, 06002, US

(21) Appl. No.: 11/203,076

(22) Filed: Aug. 12, 2005

(30) Foreign Application Priority Data
Apr. 19, 2005 (KR) 2005-32333

(51) Int. Cl. C01F 11/18

(52) U.S. Cl. 423/430

(57) ABSTRACT

Disclosed herein is a process for preparing a high-purity magnesium carbonate by mixing magnesium oxide and carbon dioxide in a reactor under optimum supercritical reaction temperature and pressure. According to the process, a high-purity magnesium carbonate can be prepared efficiently by satisfying the supercritical reaction conditions, which are easily accomplished by using the internal pressure of a liquid carbon dioxide container for supplying carbon dioxide to the reactor without using a gas booster and a supercritical pump. Therefore, the process can minimize equipment investment costs and energy consumption.

### BACKGROUND OF THE INVENTION

1. Field of the Invention

The present invention relates to a process for preparing magnesium carbonate (MgCO₃) by a supercritical reaction process of fluid. More particularly, it relates to a process for preparing magnesium carbonate by charging a magnesium oxide slurry into a reactor, supplying liq carbon dioxide to the reactor, sealing the reactor, slowly heating the sealed reactor to create a supercritical fluid state, and carrying out a chemical reaction.

2. Description of the Related Art

In general, magnesium carbonate is widely used as an ingredient of antacids in the field of pharmaceuticals, and especially, magnesium carbonate is a highly value-added product useful in the treatment of gastricism due to gastric hyperacidity. An increase of carbon dioxide in the atmosphere due to human activity has caused greenhouse effects, acidification of ocean surface waters, and changes in the ecosystem. Magnesium carbonate compounds are greatly expected to be environmentally friendly because they can be used as carbon dioxide reservoirs that are capable of preventing the increase in the concentration of carbon dioxide in the atmosphere.

U.S. Pat. No. 3,980,753 discloses a classical process for preparing magnesium carbonate by dissolving magnesite or dolomite in concentrated hydrochloric acid, and then adding sodium carbonate to the solution. However, the use of such environmentally harmful chemicals involves the problem of environmental pollution. In addition, the presence of various impurities existing in the raw mineral is an obstacle in the preparation of magnesium carbonate in a high purity. Even famous global chemical reagent manufacturers are currently preparing and selling magnesium carbonate magnesium hydroxide pentahydrate ((MgCO₃)₄Mg(OH)₂.5H₂O), which is relatively easy to prepare when compared to magnesium carbonate, as magnesium carbonate. This is because the preparation of a high-purity magnesium carbonate (MgCO₃) requires stringent reaction conditions. High-purity magnesium carbonate (MgCO₃) can be prepared only under supercritical reaction conditions. Such supercritical reaction conditions can be accomplished by the following two procedures: i) starting materials in a gas state are supplied to a reactor by using a gas booster and then heated to create a supercritical state of fluid; and ii) starting materials in a liquid state are supplied to a reactor by using a supercritical pump and then heated to create a supercritical state.

Thus, there exists a strong need for a basic technology by which a high-purity magnesium carbonate can be prepared in an environmentally friendly manner and utilized as a pharmaceutical preparation, and abnormal weather changes around the world that has been the focus of intense interest lately to mankind can be solved.

### SUMMARY OF THE INVENTION

As a result of extensive studies to solve the above-mentioned problems, it is an object of the present invention to provide a process for preparing high-purity magnesium carbonate (MgCO₃) in an environmentally friendly, energy-efficient, stable and economical manner, compared to the conventional processes, wherein magnesium oxide is used as a starting material, carbon dioxide as a principal greenhouse gas source is added in the form of liquid to a reactor by a simplified reaction procedure, thereby reducing double consumption of energy supplied to create supercritical reaction conditions, and then the temperature of the reactor is stepwise increased.

According to the present invention, there is provided a process for preparing magnesium carbonate by adding carbon dioxide in the form of liquid to magnesium oxide slurry as a starting material, heating the mixture to create supercritical reaction pressure and temperature of the fluid, and carrying out the reaction.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a diagrammatic representation schematically showing the process for preparing magnesium carbonate according to the present invention.

### DESCRIPTION OF THE PREFERRED EMBODIMENTS

The present invention will now be described in more detail.

Conventional processes for preparing magnesium carbonate use heterogeneous and impurity-rich starting materials, such as magnesite and dolomite, whereas the process of the present invention uses homogeneous magnesium oxide containing substantially no impurities. Accordingly, the process of the present invention enables the preparation of high-purity magnesium carbonate, and ensures high-quality magnesium carbonate sufficient to cause no toxicity even when administered to humans.

The process of the present invention is characterized in that a supercritical reaction process of the fluid is employed to create reaction conditions suitable for the preparation of magnesium carbonate, unlike conventional preparation processes. Since conventional processes use a gas booster or a supercritical pump to increase the reaction pressure and uses a heater to increase the reaction temperature, i.e., to create supercritical reaction conditions, considerable energy is doubly consumed. The process of the present invention is basically different from the conventional process in that supercritical reaction conditions can be satisfied without the necessity for the use of a gas booster, a thermostatic bath for refrigeration and a supercritical pump, thereby simplifying the procedure and minimizing equipment investment and energy costs.

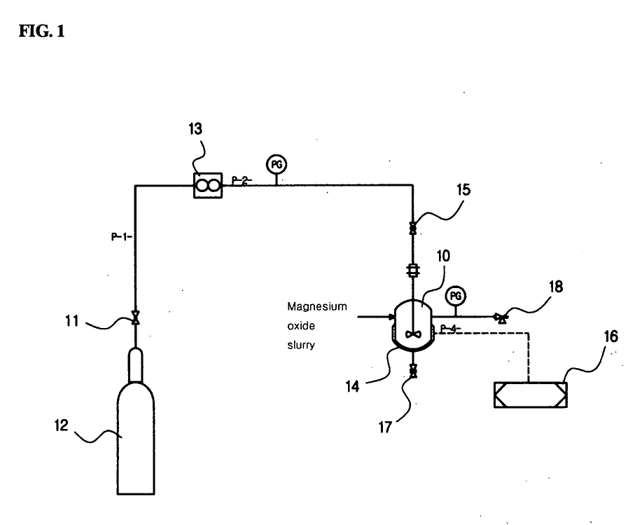

FIG. 1 is a diagrammatic representation schematically showing the process for preparing magnesium carbonate according to the present invention. The method of the present invention will be explained below with reference to FIG. 1.

First, carbon dioxide for use as a supercritical fluid is supplied to a reactor 10. At this time, a liquid carbon dioxide storage cylinder 12 fitted with a long internal tube is used for the supply of carbon dioxide, without the use of a gas booster or a supercritical pump. The internal pressure (e.g., 60˜70 bars) of the liquid carbon dioxide storage cylinder 12 enables the supply of a required amount of liquid carbon dioxide to the reactor 10 via a flow meter 13. This supply of liquid carbon dioxide is accomplished based on the fact that the critical temperature and pressure of carbon dioxide are relatively low.

The liquid carbon dioxide supplied to the reactor 10 and a magnesium oxide slurry previously contained in the reactor 10, as indicated by an arrow, are heated by a heating jacket 14 until they reach supercritical reaction conditions. e.g., 31° C. and 73.8 bars. Thereafter, the reaction is carried out for an appropriate time to yield magnesium carbonate.

The temperature of the reactor is automatically controlled by the action of a controller 16. At this time, a gas equation applied to actually adjust the reaction pressure to a necessary level is given by PV=znRT, wherein P is pressure, V is internal volume of the reactor, z is compressibility factor, R is gas constant, T is reaction temperature, and n is mole number of carbon dioxide necessary for the reaction temperature and pressure. In the gas equation, the most important factor in a real gas is a compressibility factor z. The factor z can be exactly determined by the related table.

In FIG. 1, reference numerals 11, 15, 17 and 18 denote a glove valve, a ball valve, a release valve and a rupture disk respectively, and explanations thereof are omitted.

According to the present invention, the internal pressure of the liquid carbon dioxide storage cylinder enables supply of carbon dioxide in a required amount to the reactor, and can increase and maintain supercritical reaction pressures required according to the amount of supplied carbon dioxide by increasing stepwise reaction temperatures.

The chemical reaction between magnesium oxide and carbon dioxide in a supercritical state for the preparation of magnesium carbonate comprises the following three steps. First, carbon dioxide is dissolved in water to be dissociated into hydrogen ion (H⁺) and hydrogen bicarbonate anion (HCO₃⁻). Magnesium oxide is dissolved in water to be liberated into cation Mg²⁺, and anion OH⁻. The cation Mg²⁺ react with a hydrogen bicarbonate anion HCO₃⁻ to form magnesium carbonate as a precipitate. The hydrogen ion H⁺ reacts with the anion OH⁻ to be converted to water. This reaction mechanism is simply represented by the following reaction equation:
MgO (solid)+CO₂ (supercritical fluid)+H₂O (liquid)←→MgCO₃ (solid)+H₂O (liquid)

The reaction yields magnesium carbonate as a solid crystal.

The magnesium oxide (MgO) used herein has a particle size of 150 μm or less. The magnesium oxide is dissolved in water to form a slurry having a solid content of 1˜70%. The magnesium oxide slurry is charged into the reactor, and then the carbon dioxide is maintained in a supercritical state under a pressure of 80˜350 bars at a temperature of 70˜420° C. The chemical reaction between the magnesium oxide and the carbon dioxide is carried out for 0.5˜10 hours to prepare efficiently pure magnesium carbonate (MgCO₃).

When the reaction temperature is lower than the reaction temperature range defined above, magnesium carbonate magnesium hydroxide pentahydrate ((MgCO₃)₄Mg(OH)₂.5H₂O) is prepared but pure magnesium carbonate (MgCO₃) is not prepared.

The preferred molar ratio of the carbon dioxide to the magnesium oxide consumed in the reaction is theoretically 1:1. In consideration of the creation of reaction pressure and the reaction efficiency, the carbon dioxide can be supplied up to 10 moles per mole of the magnesium oxide in order to prepare magnesium carbonate.

The present invention will now be described in more detail with reference to the following Examples. However, these Examples are not to be construed as limiting the scope of the invention.

### EXAMPLE 1

30 g of magnesium oxide and 170 g of water were mixed with stirring to form a magnesium oxide slurry. The slurry was charged into a reactor, and then 107 g of liquid carbon dioxide was supplied to the reactor by using the internal pressure (70 bars) of the liquid carbon dioxide. After the reactor was sealed by closing a supply valve, the pressure reached 160 bars while the temperature was raised to 140° C., and then reacted for 2 hours.

The resulting reaction mixture was filtered, and dried in an oven at 110° C. for 24 hours to remove moisture. The product was qualitatively analyzed by using an X-ray diffiactometer (XRD) and the yield thereof was measured using a thermogravimetric analyzer (TGA). As a result, it was proven that the product was magnesium carbonate (MgCO₃) showing main crystal peaks at 2θ=30.8°, 32.8°, 35.8°, 42.9°, 46.8°, 53.7° and 70.3° and having a purity of 98.2%.

### COMPARATIVE EXAMPLE 1

30 g of magnesium oxide and 170 g of water were mixed with stirring to form a magnesium oxide slurry. The slurry was charged into a reactor, and then 139 g of liquid carbon dioxide was supplied to the reactor by using the internal pressure (70 bars) of the liquid carbon dioxide. After the reactor was sealed by closing a supply valve, the pressure reached 160 bars while the temperature was raised to 60° C., and then reacted for 2 hours.

The resulting reaction mixture was filtered, and dried in an oven at 110° C. for 24 hours to remove moisture. The product was qualitatively analyzed by using an X-ray diffractometer (XRD). As a result, it was proven that the product was magnesium carbonate magnesium hydroxide pentahydrate ((MgCo₃)₄Mg(OH)₂.5H₂O) instead of magnesium carbonate.

As apparent from the foregoing, the process of the present invention uses magnesium oxide and liquid carbon dioxide as starting materials, and has been achieved based on the finding that liquid carbon dioxide has relatively low critical points. Based on these advantages, according to the process of the present invention, supercritical reaction conditions which are necessary for the preparation of magnesium carbonate can be satisfied without using an additional fluid compression equipment, thereby simplifying the procedure and minimizing equipment investment and energy costs involved in the process.

In addition, the process of the present invention enables the preparation of high-purity magnesium carbonate, which is difficult to prepare due to the limitations of supercritical reaction conditions, by a simplified supercritical fluid process by using impurity-free starting materials. Furthermore, according to the process of the present invention, a basic technology is ensured that high-purity magnesium carbonate prepared by the process of the present invention can be used as a highly value-added antacids and as a carbon dioxide reservoir capable of preventing the increase in the concentration of greenhouse gases in the atmosphere, which is a major threat to humans.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A process for preparing magnesium carbonate by a supercritical reaction process of the fluid, comprising:
supplying carbon dioxide in the form of liquid to magnesium oxide slurry as starting materials;
heating the mixture to create supercritical reaction pressure and temperature of the fluid; and then reacting the reaction mixture.

2. The process according to claim 1, wherein the supply of carbon dioxide is carried out by the internal pressure of a carbon dioxide container without using an additional gas booster or a supercritical pump.

3. The process according to claim 1, wherein the carbon dioxide is supplied in an amount of 1˜10 moles, based on one mole of the magnesium oxide.

4. The process according to claim 1, wherein the magnesium oxide has a particle size of 150 μm or less, and is dissolved to form a slurry having a solid content of 1˜70%.

5. The process according to claim 1, wherein the supercritical reaction process of the fluid is carried out under a pressure of 80˜350 bars at a temperature of 70˜420° C. for 0.5˜10 hours.

6. The process according to claim 3, wherein the magnesium oxide has a particle size of 150 μm or less, and is dissolved to form a slurry having a solid content of 1˜70%.
